(19) United States
(12) Patent Application Publication
(10) Pub. No.: US 2003/0014746 A1
(43) Pub. Date: Jan. 16, 2003

(54) Method for audience measurement of interactive applications broadcast or intergrated on a television receiver decoder

(76) Inventor: Pascal Giroux, Saint-Cyr-L'Ecole (FR)

Correspondence Address: PIPER RUDNICK, P. O. BOX 64807, CHICAGO, IL, 60664-0807, US

(21) Appl. No.: 10/203,401

(22) PCT Filed: Nov. 27, 2001
(86) PCT No.: PCT/FR01/03745

(30) Foreign Application Priority Data
Dec. 14, 2000 (FR) 00/16308

(51) Int. Cl. H04N 7/16; H04H 9/00

(52) U.S. Cl. 725/14; 725/9

(57) ABSTRACT

The invention concerns a method for audience measurement of interactive applications, by detecting the application with a measuring device connected to the receiver. It consists, for an interactive application (IAI) subdivided into steps of successive significant representations (SSᵢ), in transmitting (T) from the receiver to the audience measuring device when each significant step (SSᵢ) is shifted an information representing said application (IAI) and of the completed significant step. The invention is applicable to automated management of interactive applications.

The invention relates to a method for audience measurement of interactive applications which are telebroadcast or integrated on a television receiver decoder or a video recorder.

In a general manner, the services for broadcasting or telebroadcasting televised programs allow, for the benefit of viewer users, the presentation of interactive applications exhibiting a recreational character, for entertainment purposes, or an informative character. More specifically, these interactive applications may be presented either by telebroadcasting, from the telebroadcasting network head end for example, or from software integrated at decoder level.

In either case, measurements aimed at verifying the audience for such interactive applications make it possible, on the basis of an audience measurement module, interconnected to the decoder or, as the case may be, incorporated into the latter, to ascertain at least the instant of selection and hence of running of the interactive application by the user, when this, telebroadcast, application is identifiable by way of the conventional DVB triple, the initials standing for Digital Video Broadcasting, as well as the precise instant at which this user exits this application so as to select another telebroadcast program for example, itself identified by a different DVB triple. This information may be transmitted, either via an STN link by modem or, as the case may be, via a specialized link to an audience research management body, so as to take account of the audience results and listening time results for example.

Such a mode of operation does not allow finer discrimination of the habitual listening behavior of users.

In particular, even in the case of the use of managers of current telebroadcast programs or interactive applications such as OPEN-TV®, it is not possible to ascertain in which part of the application the user has spent the majority of his connection time to the selected interactive application.

Furthermore, an interactive application integrated into the decoder, for example the general menu of the decoder, is not generally identified by a DVB triple. This type of application cannot therefore be incorporated at the audience measurement level.

The object of the present invention is to remedy the aforesaid drawbacks of the processes of the prior art implemented.

In particular, an object of the present invention is the implementation of a method for audience measurement of interactive applications telebroadcast or integrated on a television receiver decoder, allowing monitoring of the listening and reaction behavior of the user of high accuracy.

Another object of the present invention is furthermore, by virtue of the implementation of monitoring of the listening and reaction behavior of the user, the obtaining of genuine behavioral profiles of each user.

Another object of the present invention is also, independently of the telebroadcast or integrated character of the various interactive applications, the implementation of an especially reliable and accurate inter-application method for audience measurement of applications.

Another object of the present invention is also, independently of the telebroadcast or integrated character of the various interactive applications, the implementation of an especially reliable and accurate inter-application method for audience measurement of applications, the various functional scenes of any application possibly forming the subject of a specific scene audience measurement, so as to make it possible to classify any interactive application having regard to the results of potential or actual audience making up the latter.

The method for audience measurement of interactive applications, which is the subject of the present invention, an interactive application being received by a user and represented on a receiver provided with a display system, the audience measurement being effected by detection of the application by an audience measurement device connected to the receiver, is noteworthy in that it consists, for an interactive application subdivided into successive significant steps of representation, in transmitting from the receiver to the audience measurement device, upon the completion of each significant step, an information item representative of this application and of the completed significant step.

The method which is the subject of the present invention finds application in the automated management of interactive applications which are telebroadcast from a telebroadcasting network head end or are integrated on a telebroadcasting receiver decoder.

It will be better understood on reading the description and on looking at the drawings hereinbelow, in which:

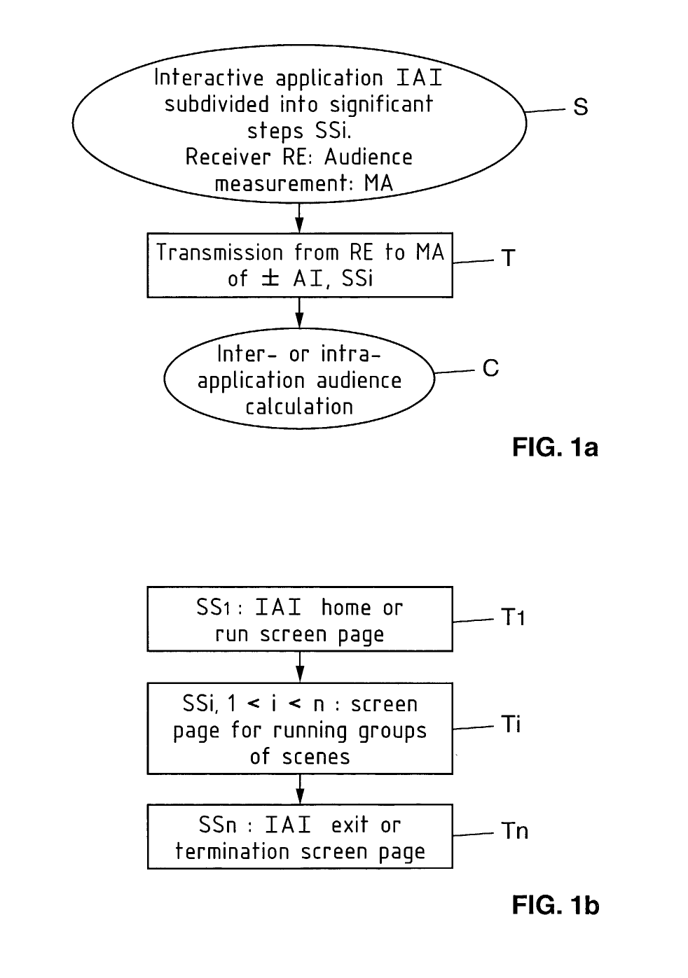

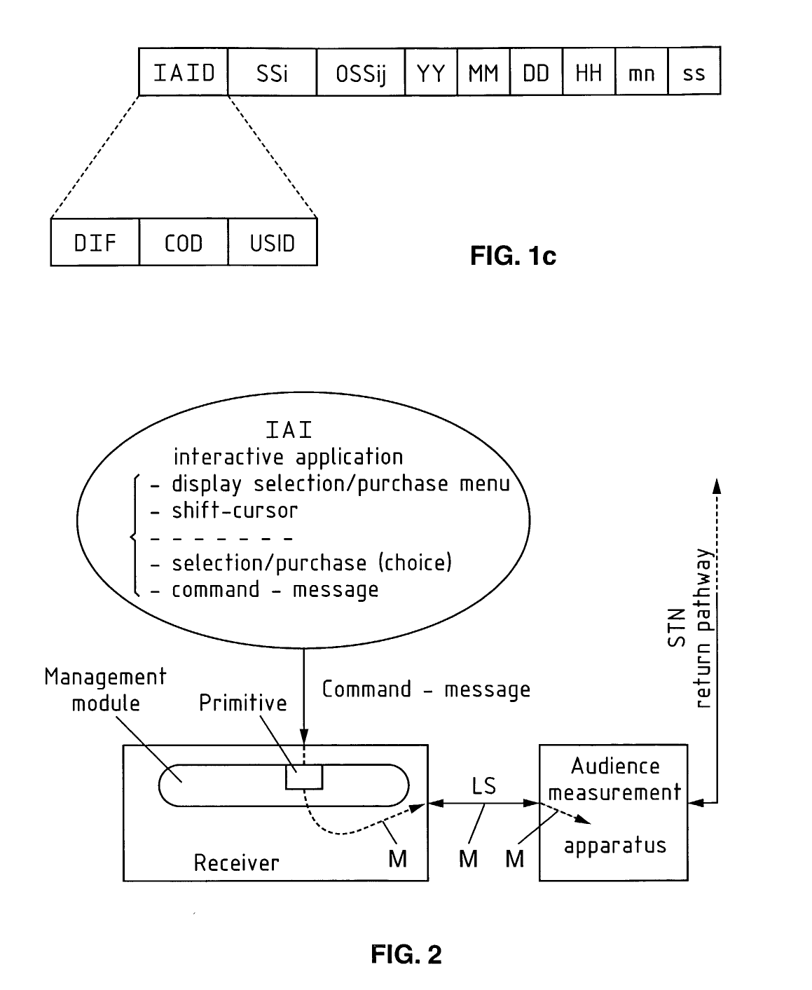

FIG. 1a represents, by way of illustration, a general flow chart for implementing the method which is the subject of the present invention;

FIG. 1b represents, by way of illustration, a detail of the implementation of a specific step of the method which is the subject of the present invention, as represented in FIG. 1a, in a non-limiting preferred embodiment;

FIG. 1c represents, by way of illustration, a structure of a message supporting the information representative of the application and of the completed significant step allowing the implementation of the method which is the subject of the present invention as represented in FIGS. 1a and 1b;

FIG. 2 represents, by way of illustration, a schematic diagram representative of the process for transmitting from the receiver furnished with the display system to the audience measurement device, messages such as the one represented in FIG. 1c;

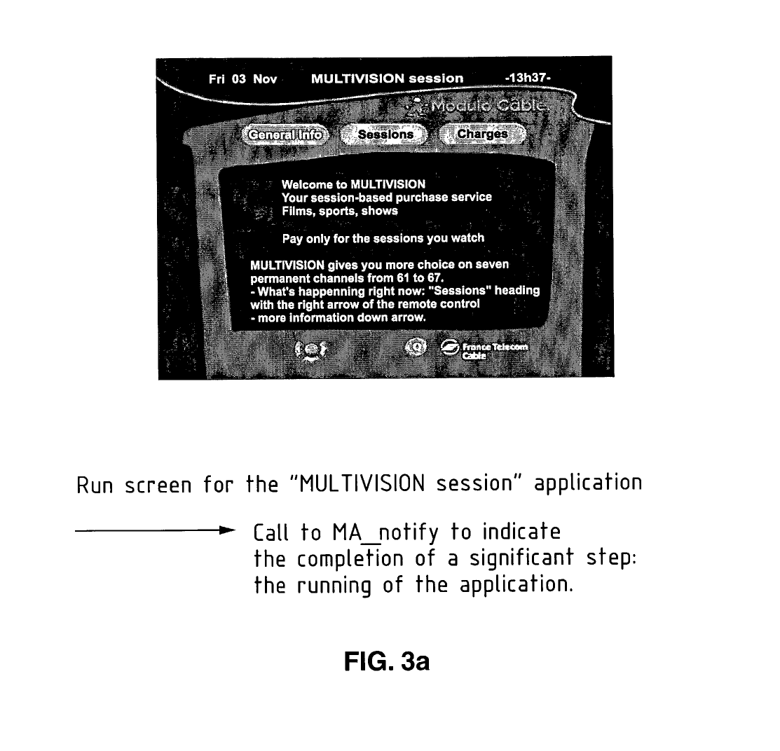

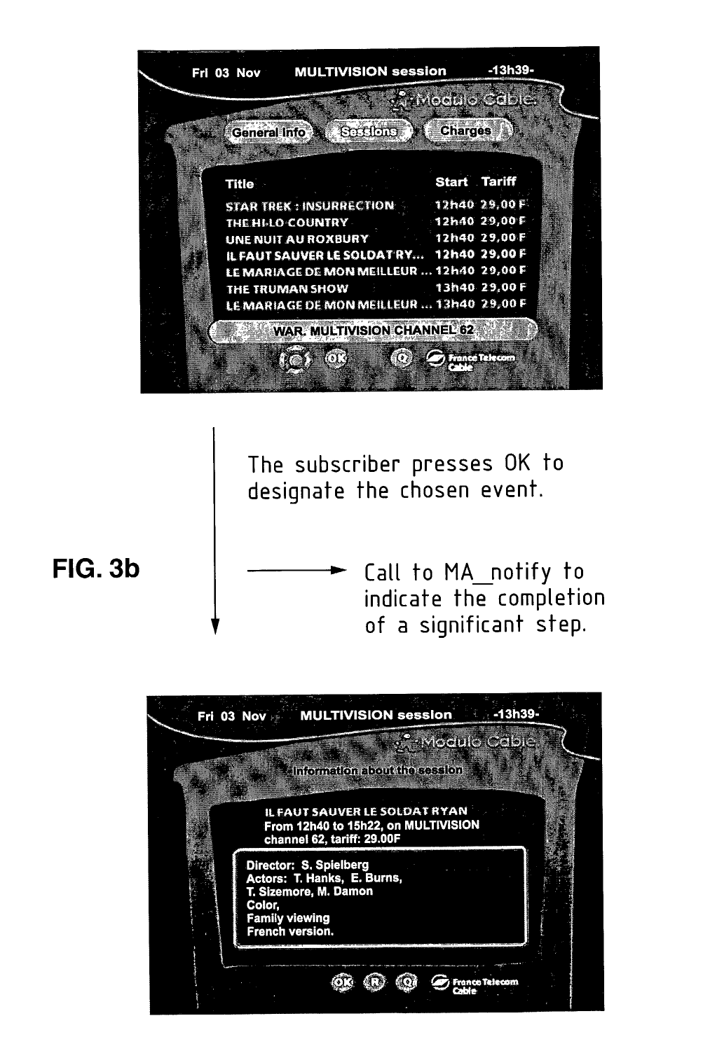

FIGS. 3a and 3b represent, by way of non-limiting example, a succession of screen pages of a specific interactive application allowing the dispatching of successive messages to the audience measurement device in accordance with the process represented in FIG. 2.

A more detailed description of the method for audience measurement of interactive applications telebroadcast or integrated on a television receiver decoder or a video recorder decoder, which is the subject of the present invention, will now be given in conjunction with FIG. 1a and the following figures.

In a general manner, it is recalled that television receiver apparatus or, as the case may be, video recorders, are customarily equipped with a decoder.

This decoder usually takes the form of a module connected to the network for telebroadcasting programs. The constituent module of the decoder makes it possible, in addition to the operations required for the reception of the telebroadcast programs, to perform the implementation of specific functions which are not incorporated into the television receiver, these functions comprising, for example the control of access to the telebroadcast transmissions and a link with a so-called return pathway to the authority responsible for the management of the telebroadcasting network by way of a telephone line for example, hooked up directly to the decoder module.

Thus, the decoder module comprises an output pathway connected to the television receiver or to the video recorder so as to ensure the transmission of the telebroadcast program unencrypted after decoding, as well as an output for linking to the switched telephone network for example, to ensure the operations of management by way of the return pathway.

The method which is the subject of the present invention makes it possible in particular to circumvent the constraints of detection of certain physical parameters of the telebroadcast-program signals, such as for example their carrier frequency or DVB triple.

In particular, with reference to FIG. 1a, the situation considered is that of the starting situation S according to which an interactive application IAI is received by a user on his television receiver for example and represented on the latter, furnished of course with a display system.

It is understood in particular that an audience measurement device is moreover connected to the receiver by way of the decoder, as mentioned previously in the description, with a view to effecting audience measurement by detection of the interactive application used by the user when this interactive application is displayed on the television receiver of the latter.

In particular, a given interactive application IAI is considered, which is subdivided into significant steps, denoted SSᵢ, these significant steps being of course successive significant steps of representation, as will be described subsequently in the description.

As represented in FIG. 1a, the method which is the subject of the present invention consists, in respect of the relevant interactive application IAI subdivided into successive significant steps of representation SSᵢ, in transmitting, in step T, from the television receiver, on the basis of the decoder for example, to the audience measurement device MA, an information item representative of the application and of the completed significant step.

With reference to FIG. 1a, it is understood that, with each completion of each significant step SSᵢ, the method, which is the subject of the present invention, consists in transmitting together with an identification number for the interactive application IAI a reference number or code number of the completed step SSᵢ.

The step T of transmission possibly relating to several completions of significant steps, may then be followed by a step C of inter- or intra-application audience calculation under the conditions which will be described subsequently in the description.

In a general manner, it is indicated that the inter-application audience calculation can be carried out on the basis of any significant step of running an application, that is to say the first step of implementing this application, which may be regarded as significant of the running of the relevant application by the user, whereas the intra-application audience calculation may be effected for the relevant interactive application IAI and for each of these applications on the basis of the information and of the codes allocated at each subsequent significant step to the screen for running the relevant application.

In a general manner, and for the implementation of the transmission step T represented in FIG. 1a, it is indicated, with reference to FIG. 1b, that, for a given specified interactive application IAI, the successive significant steps of representation comprise at least the representation of a home screen page or of a screen page for the running of the telebroadcast application, this representation corresponding to the significant step SSᵢ, in FIG. 1b, as the case may be, and as a function of the nature of the application and of the latter's character, recreational or otherwise, of the screen pages for running groups of constituent scenes of an interactive functional unit in a relevant application, the corresponding successive significant steps of rank 1<i<n being defined on the initiative of the operator or of the interactive application distributor as a function of the nature of the relevant interactive application.

Finally, the successive significant steps of representation comprise the representation of an exit screen page or of a screen page for the termination of the interactive telebroadcast application in step Tₙ in FIG. 1b, the information item representative of the corresponding step being denoted SSₙ in the aforesaid figure.

By way of non-limiting example, and for an application distributed by the TPS company, the initials standing for Télévision par Satellite, in France, application designated BANDIAGRA®, such an application can be represented schematically as a first entry menu which allows the subscriber to select the game which he wishes to execute. When the chosen game has been run, the subscriber can either return to the original menu, or switch, that is to say zap to another program. The return to the menu is also automatic when the user subscriber has terminated his turn at the game.

In such a context, the significant steps of the execution may be:

the running of the application, that is to say the presentation of the main menu;

the running of each game;

the stopping of the application, case of switching or zapping, to another program.

To ensure the transmission of the information representative of the application and of the completed significant step, such a transmission may be carried out on the basis of a specific message containing a set of parameters comprising at least, as represented in FIG. 1c, a variable for identifying the interactive application, variable denoted IAID and of course a variable for identifying the completed significant step, that is to say the code of the aforesaid step SSᵢ.

Furthermore, as represented in FIG. 1c, the set of constituent parameters of the message may comprise a specific variable representative of an option relating to the completed significant step, this option variable being denoted OSSᵢⱼ.

It is understood in particular that for an interactive application with multiple choices, these choices may be made by the user, with the remote control of the television receiver, on the basis of a decisional tree which is presented to him on the display screen of the relevant interactive application. For a current step SSᵢ, the user can then benefit from the possibility of several choices and, consequently, make the choice of a specified option from this plurality. Thus, the option variable relating to the completed significant step, variable OSSᵢⱼ, makes it possible to represent the possibility of the aforesaid choices among the plurality of choices and to monitor as it were the behavior of the user, and thereby, of a plurality of users constituting a group of specific users.

Preferably, as represented moreover in FIG. 1c, the information representative of the application and of the completed significant step may comprise a data field representative of the date and of the time of completion of the significant step, this data field being represented in FIG. 1c in a conventional manner by a field relating to the year YY, a field relating to the month of the year MM, a field relating to the day DD, a field relating to the hour HH, a field relating to the minutes min and finally, a field relating to the seconds ss.

By way of non-limiting example, it is also possible to provide, if necessary, a field relating to fractions of a second, all of the aforesaid fields, year, month, day, hour, minutes, seconds and as the case may be fraction of a second, being activatable only upon the existence of an option effected by the user and consequently upon the selection by the latter of this option engendering the creation of the relevant option variable OSSᵢⱼ.

In a general manner, it is indicated that each variable and each field for a variable advantageously consists of an alphanumeric variable.

Finally, as far as the variable for identifying the interactive application IAID is concerned, it is indicated that the latter, as represented also in FIG. 1c, can comprise a field of alphanumeric data representative of the authority ensuring the representation of the interactive application, this field being denoted DIF in FIG. 1b. The authority ensuring the representation of the interactive application is that which ensures either the telebroadcasting of the telebroadcast program when the interactive application is transmitted from a telebroadcasting network head end for example, or as the case may be the authority which ensures the distribution of the interactive application and the incorporation of the latter into a decoder for example.

As represented furthermore in FIG. 1c, the variable for identifying the interactive application IAID furthermore comprises a field representative of the type of receiver used, this field being denoted COD in FIG. 1c and possibly corresponding, for example, to the type of display format of the television, 16/9 or 4/3 format, or of other specific reception parameters of the relevant receiver.

Finally, the variable for identifying the interactive application IAID comprises, as represented in FIG. 1c, an alphanumeric data field representative of a user reference, this field being denoted USID. It is indicated more particularly that this data field representative of the user reference can be coded and that the code used is independent and does not permit any unauthorized access to personal data relating to the relevant user.

The mode of operation for carrying out the transmission of the information representative of the application and of the completed significant step, so as to make it possible to ensure the implementation of the method which is the subject of the present invention, will now be described in conjunction with FIG. 2.

Represented in FIG. 2 is the TV receiver, denoted Receiver, with which a specific decoder is for example incorporated. The specific decoder comprises a software module for managing the method which is the subject of the present invention, and of course, for the execution of the relevant interactive application IAI.

It is recalled that the interactive application IAI makes it possible to execute:

the displaying of a selection/purchase menu by the subscriber user,

the shifting of the cursor by a remote control of the television receiver and in particular

the selection or purchase, that is to say the choice, from the various options offered to the user in respect of the relevant interactive application.

Furthermore, the aforesaid interactive application makes it possible to engender a message run command, denoted Command_message, making it possible to call a specific primitive, such as a primitive MA_notify in a context of the OPEN-TV® type, the aforesaid primitive MA_notify more specifically designating an audience measurement primitive making it possible to engender the message structure represented in FIG. 1c for example, so as to ensure the transmission of the information representative of the application and of the completed significant step. The message structure M is then transmitted from the receiver to the audience measurement apparatus by way of a serial link LS for example. The audience measurement apparatus then proceeds to the storage of the data contained in the aforesaid message structure M and can ensure, subsequent to the storage of a sufficient quantity of information relating to the information regarding completion of significant step of one or more applications, this information constituting audience measurement data for interactive applications, then to the transmission of these data via the return pathway to the switched telephone network for example.

A more specific example of the implementation of the method which is the subject of the present invention, relating to an application dubbed “MULTIVISION session” will now be represented in conjunction with FIGS. 3a and 3b.

Represented in FIG. 3a is the run screen of the “MULTIVISION session” application offering a session-based purchase service for films, sports, or shows to a subscriber furnished with subscription rights to the aforesaid interactive application.

As soon as the application is run, that is to say upon the appearance of the home screen or run screen for the aforesaid interactive application, with reference to FIG. 2, it is indicated that a call to the primitive MA_notify is effected so as to transmit for example the step information SS₁ of step T₁, of FIG. 1b.

It is indicated that the “multivision session” interactive application allows the subscriber user to pay only for the sessions which he/she watches. Of course, the home page comprises the instructions given to the user to continue the selecting of the film, the sport or the show which he wishes to view.

Subsequent to the running of the application and of the corresponding home or run page, a menu of choices of various films for example is displayed for the user who has chosen the “sessions” option corresponding to film screening sessions.

After shifting the cursor in order to highlight one of the titles of films screened in a session, with each film title there being associated the start time for the telebroadcasting of this film as well as the corresponding tariff, the subscriber user presses for example the OK command to designate the highlighted chosen session. The aforesaid choice, corresponding to an option event, instigates a call to the primitive MA_notify to indicate the completion of the corresponding significant step.

Subsequent to this choice, as represented also in FIG. 3b, a screen giving information about the chosen session, bearing the title “IL FAUT SAUVER LE SOLDAT RY . . . ” in FIG. 3b, gives specific indications as to the conditions of viewing of such a film, this information possibly containing the name of the director, the name of the principal actors and indications of censor rating or of accessibility to young viewers.

1. Method for audience measurement of interactive applications, an interactive application being received by a user and represented on a receiver provided with a display system, the audience measurement being effected by detection of the application by an audience measurement device connected to the receiver, characterized in that said method consists, for an interactive application subdivided into successive significant steps of representation, in transmitting from the receiver to the audience measurement device, upon the completion of each significant step, an information item representative of this application and of the completed significant step.

2. Method according to claim 1, characterized in that, for a specified interactive application, said successive significant steps of representation comprise at least:
the representation of a home screen page or of a screen page for the running of the telebroadcast application;
the representation of an exit screen page or of a screen page for the termination of the interactive telebroadcast application.

3. Method according to claim 1 or 2, characterized in that said successive significant steps of representation furthermore comprise the representation of the screen page for running groups of constituent scenes of an interactive functional unit.

4. Method according to one of claims 1 to 3, characterized in that the information item representative of the application and of the completed significant step consists of a set of parameters comprising at least:
a variable for identifying the interactive application;
a variable for identifying the completed significant step.

5. Method according to claim 4, characterized in that said set of parameters furthermore comprises a specific variable representative of an option relating to the completed significant step.

6. Method according to claim 4 or 5, characterized in that each variable consists of an alphanumeric variable.

7. Method according to claim 4 or 5, characterized in that said variable for identifying the interactive application comprises:
an alphanumeric data field representative of the authority ensuring the representation of the interactive application;
an alphanumeric data field representative of the type of receiver used;
an alphanumeric data field representative of a user reference.

8. Method according to one of claims 4 to 7, characterized in that said information item representative of the application and of the completed significant step furthermore comprises a data field representative of the date and of the time of completion of said significant step.
